(19) United States
(12) Patent Application Publication
(10) Pub. No.: US 2022/0407151 A1
(43) Pub. Date: Dec. 22, 2022

(54) ELECTROCHEMICAL ELEMENT, AS WELL AS MODULES AND BATTERIES CONTAINING SAME

(71) Applicant: SAFT, LEVALLOIS PERRET (FR)

(72) Inventors: Vincent PELE, BORDEAUX (FR); Christian JORDY, ST LOUIS DE MONTFERRAND (FR); Nadège ROUMEGOUS, AMBARES ET LAGRAVE (FR)

(73) Assignee: SAFT, LEVALLOIS PERRET (FR)

(21) Appl. No.: 17/779,192

(22) PCT Filed: Nov. 27, 2020
(86) PCT No.: PCT/EP2020/083742

§ 371 Date: May 24, 2022

(30) Foreign Application Priority Data
Nov. 29, 2019 (FR) FR193453

(51) Int. Cl. H01M 50/102; H01M 10/0525; H01M 10/0562; H01M 10/0585; H01M 50/204; H01M 50/24; H01M 50/231; H01M 50/229; H01M 50/124; H01M 50/122; H01M 50/14; H01M 50/133

(52) U.S. Cl. CPC H01M 50/102; H01M 10/0525; H01M 10/0562; H01M 10/0585; H01M 50/204; H01M 50/24; H01M 50/231; H01M 50/229; H01M 50/124; H01M 50/122; H01M 50/14; H01M 50/133; H01M 2300/0068

(57) ABSTRACT

This invention concerns an electrochemical element, in particular a sulphurous solid electrolyte element, comprising a protective casing, as well as modules and batteries comprising such elements.

### CROSS REFERENCE TO RELATED APPLICATIONS

The present application is a U.S. National Phase Application under 35 U.S.C. § 371 of International Patent Application No. PCT/EP2020/083742 filed Nov. 27, 2020, which claims priority of French Patent Application No. 19 13453 filed Nov. 29, 2019. The entire contents of which are hereby incorporated by reference.

### FIELD OF INVENTION

This invention concerns the field of energy storage, more specifically batteries, in particular lithium batteries.

### BACKGROUND

Indeed, rechargeable lithium-ion batteries provide excellent energy and bulk density, and currently lead the portable electronics, electric and hybrid vehicle, and stationary energy storage system markets.

Their operation is based on the reversible exchange of lithium ions between a positive electrode and a negative electrode that are separated by an electrolyte.

Additionally, solid electrolytes provide a considerably improvement in terms of safety, given that their fire risk is much lower than liquid electrolytes.

However, the properties of solid electrolytes deteriorate in contact with moisture. In the case of sulphurous electrolytes, moisture results in particular in the emission of harmful gas (H₂S).

Thus, it is worthwhile to develop solutions to protect the components of solid electrochemical cells in order to prolong their useful life.

US2016/0351973 describes a protective nanolayer for the active material of the anode, cathode, or electrolyte. However, the layer is described at the interface between the active material and the electrolyte, and has the effect of hindering electronic transfer between the active layer and the passivation layer that form on the electrode surface.

US2019/0013546 describes the encapsulation of a solid electrolyte by a nanofilm, wherein the film encapsulates the electrolyte over all surfaces of the electrolyte in order to protect it during storage or battery manufacture.

US2016/0293907 describes the outer packaging of an interdigital multilayered stack, as well as its inner encapsulation, which, however, covers the entire battery arrangement. However, the batteries described are thin-layer microbatteries, and do not contain sulphurous electrolytes. The encapsulation or packaging described is nonetheless insufficient in terms of effective prevention of contact between an electrolyte, in particular a sulphurous electrolyte, and the atmosphere, and the constraints related to ‘macroscopic’ batteries, compared to microbatteries (mechanical stresses, volume variations, roughness, materials used, etc.).

Thus, effective protection of sulphurous electrolytic surfaces exposed to trace moisture in order to insulate them and avoid any deterioration of their component materials is yet to be provided. Moreover, the protection must also allow for compensation of volume variations of electrodes, the dimensions of which may substantially vary (more than 10 μm, unlike thin-layer microbatteries). Moreover, the electrochemical performance of the cell should not be affected.

### SUMMARY

Thus, one of the objectives of the invention is to attain these objectives by proposing an electrochemical cell comprising a protective casing applied over all or part of the electrolytic material that may come in contact with moisture, in particular over all or part of the lateral outer surface of the electrolytic layer of the stack of negative electrode/electrolyte/positive electrode and/or the surface of the electrodes that may contain an electrolytic component.

According to a first object, this invention concerns an electrochemical element comprising at least one sulphurous electrolytic compound, wherein the element comprises a stack of two conductive electronic current collectors, wherein the stack comprises:
a positive electrode;
a negative electrode; and
a layer comprising a solid electrolytic composition separating the positive electrode and the negative electrode;
   wherein the cell is characterized in that at least the lateral surface of the stack is at least partially covered with a chemical protection and/or mechanical reinforcement casing that is electrically insulating.

Electrochemical element' refers to an elementary electrochemical cell consisting of an assembly of a positive electrode/electrolyte/negative electrode that allows for the storage of the electrical energy provided by a chemical reaction and to restore it in the form of current. In the context of this invention, the positive electrode may be of any known type. The cathode generally consists of a conductive support that is used as a current collector and covered with a layer containing the active cathodic material and, generally, also a binder and an electronically conductive material.

There are no particular limits for the active cathodic material. It may be selected from the following groups or mixtures thereof:
a compound (a) having the formula LiₓM_{1-y-z-w}M′_{y}M″_{z}M′″_{w}O₂ (LMO2), wherein M, M′, M″, and M′″ are selected from the group consisting of B, Mg, Al, Si, Ca, Ti, V, Cr, Mn, Fe, Co, Ni, Cu, Zn, Y, Zr, Nb, W, and Mo, provided that at least M or M′ or M′ or M′″ is selected from Mn, Co, Ni, or Fe; wherein M, M′ , M″ , and M′″ are different to one another; and 0,8 [symbol] x [symbol] 1.4; 0 [symbol] y0.5; 0 [symbol] z [symbol] 0.5; 0 [symbol] w [symbol] 0.2 et x+y+z+w<2.1;
a compound (b) having the formula LiₓMn_{2-y-z}M′_{y}M″_{z}O₄ (LMO), wherein M′ and M″ are selected from the group consisting of B, Mg, Al, Si, Ca, Ti, V, Cr, Fe, Co, Ni, Cu, Zn, Y, Zr, Nb, and Mo ; wherein M′ and M″ are different to one another, and 1 [symbol] x [symbol] 1.4; 0 [symbol] y [symbol] 0.6; 0 z [symbol] 0.2;
a compound (c) having the formula LixFe1-yMyPO4 (LFMP) , wherein M′ is selected from the group consisting of B, Mg, Al, Si, Ca, Ti, V, Cr, Mn, Co, Ni, Cu, Zn, Y, Zr, Nb, and Mo; and 0.8 [symbol] x [symbol] 1.2; 0 [symbol] y0.6;
a compound (d) having the formula LixMn1-y-zM′yM″zPO4(LMP), wherein M′ and M″ are different to one another and are selected from the group consisting of B, Mg, Al, Si, Ca, Ti, V, Cr, Fe, Co, Ni, Cu, Zn, Y, Zr, Nb, and Mo; wherein 0.8 [symbol] x [symbol] 1.2; 0 [symbol] y [symbol] 0.6; 0 [symbol] z [symbol] 0.2;
a compound (e) having the formula xLi₂MnO₃:LiMO₂, wherein M is at least one element selected from Ni, Co, and Mn, and x [symbol] 1.
a compound (f) having the formula Li₁₊ₓMO_{2-y}F_{y} with a cubic structure, wherein M is at least one element selected from the group consisting of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd, and Sm, and wherein 0 [symbol] x [symbol] 0.5 and 0 [symbol] y [symbol] 1.

Preferably, the current collector is a 2-dimensional conductive support such as a carbon- or metal-based full or perforated strip, e.g. of steel, stainless steel, or aluminum, preferably aluminum. The current collector may be coated on one or both surfaces with a carbon layer.

In the context of this invention, the negative electrode may be of any known type. It generally consists of a conductive support that is used as a current collector and covered with a layer containing the active anodic material and, generally, also a binder and an electronically conductive material.

It is understood that, in ‘free-anode’ systems, a negative electrode is also present (generally initially limited to the current collector).

There are no particular limits for the active cathodic material. It may be selected from the following groups and mixtures thereof:
Metallic lithium or a metallic lithium alloy
Graphite
Silicon
Free anode
a titanium-niobium oxide having the formula:

LiₓTi_{a-y}M_{y}Nb_{b-z}M′_{z}O_{((x+4a+5b)/2)-c-d}X_{c}
wherein 0 [symbol] x [symbol] 5; 0 [symbol] y [symbol] 1;0 [symbol] z [symbol] 2; 1 [symbol] a [symbol] 5; 1 [symbol] b [symbol] 25; 0.25 [symbol] a/b [symbol] 2; 0 [symbol] c [symbol] 2 et 0 [symbol] d [symbol] 2; a−y>0; b−z>0;
M and M′ are each at least one element selected from the group consisting of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd, and Sm;
   X is at least one element selected from the group consisting of S, F, Cl, and Br.
   d indicates an oxygen vacancy. d may be less than or equal to 0.5.

The at least one titanium-niobium oxide may be selected from TiNb₂O₇, Ti₂Nb₂O₇, Ti₂Nb₂O₉, and Ti₂NB₁₀O₂₉.
a lithiated titanium oxide or a titanium oxide that can be lithiated. LTO is selected from the following oxides:
i) Liₓ₋ₐMₐTi_{y-b}M′_{b}O_{4-c-d}X_{c}, wherein 0<x [symbol] 3; 1 [symbol] y [symbol] 2.5; 0 [symbol] a [symbol] 1; 0 [symbol] b [symbol] 1; 0 [symbol] c [symbol] 2; and −2.5 [symbol] d [symbol] 2.5;
   M is at least one element selected from the group consisting of Na, K, Mg, Ca, B, Mn, Fe, Co, Cr, Ni, Al, Cu, Ag, Pr, Y, and La;
   M′ is at least one element selected from the group consisting of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y, and Eu;
   X is at least one element selected from the group consisting of S, F, Cl, and Br;
   d indicates an oxygen vacancy. d may be less than or equal to 0.5.
ii) HₓTi_{y}O₄, wherein 0 [symbol] x1: 0y 2, and
iii) a mixture of the compounds i)-ii).

Examples of lithiated titanium oxides of the group i) include spinel Li₄Ti₅O₁₂, Li₂TiO₃, ramsdellite Li₂Ti₃O₇, LiTi₂O₄, LiₓTi₂O₄, wherein 0<x2, and Li₂Na₂Ti₆O₁₄.

A preferred LTO compound has the formula Li₄₋ₐMₐTi_{5-b}M′_{b}O₄, e.g. Li₄Ti₅O₁₂, also expressed as Li_{4/3}Ti_{5/3}O₄.

The binder present in the cathode and anode has the function of reinforcing the cohesion between the particles of active materials, as well as improving the adherence of the mixture according to the invention to the current collector. The binder may contain one or more of the following elements: polyvinylidene fluoride (PVDF) and copolymers thereof, polytetrafluoroethylene (PTFE) and copolymers thereof, polyacrylonitrile (PAN), poly(methyl)- or (butyl)methacrylate, polyvinyl chloride (PVC), poly(vinyl formal), polyester, sequenced polyetheramides, polymers of acrylic acid, methacrylic acid, acrylamide, itaconic acid, sulphonic acid, elastomer, and cellulosic compounds. The one or more elastomers that may be used as a binder may be selected from styrene-butadiene (SBR), butadiene-acrylonitrile (NBR), hydrogenated butadiene-acrylonitrile (HNBR), and a mixture of several thereof.

The electronically conductive material is generally selected from graphite, carbon black, acetylene black, soot, grapheme, carbon nanotubes, or a mixture thereof.

The element according to the invention has an assembly in the form of a stack, which defines a lower surface and an upper surface opposite it, and an outer lateral peripheral surface, on which the electrodes and the electrolytic layer are generally in contact with the atmosphere. According to the invention, at least the lateral outer surface of the electrolytic layer is at least partially covered with the protective casing in order to avoid contact with the atmosphere.

The casing covers all or part of the lateral surface of the elementary stack of an element in that it covers at least part of the lateral surface of the electrolytic layer, but it may also cover the entire lateral surface of the electrolytic layer and the lateral surface of the electrodes.

It is understood that the casing may be partially present, inter alia, in the interstices that may form between the electrodes and the electrolytic layer. The casing may also cover the outer surfaces of the electrodes of the element (except for connector elements). Nonetheless, the casing does not totally cover the internal interfaces between the electrolytic layer and the electrodes.

The electrochemical elements according to the invention that are referred to herein as ‘macrobatteries’ typically have an electrical charge greater than 100 mAh. They differ from microbatteries, and typically have a capacity greater than 0.1 Ah.

The term ‘module’ refers herein to the assembly of several electrochemical elements.

‘Battery’ refers to the assembly of several modules.

The assemblies may be in series and/or parallel.

The electrochemical element according to the invention is particularly well suited to lithium batteries, such as Li-ion batteries, primary Li (non-rechargeable), and Li—S batteries.

Current collector' refers to an element such as a bump, plate, sheet, etc. of conductive material, connected to the positive or negative electrode and ensuring the conduction of the electron flow between the electrode and the terminals of the battery.

Positive electrode' refers to the electrode into which the electrons enter, and where the discharged cations (Li+) arrive.

Negative electrode' refers to the electrode from which the electrons depart, and from which the discharged cations (Li+) are release.

The electrochemical element comprises at least one sulphurous (i.e. sulphur-containing) electrolytic compound.

The electrolytic layer contains an electrolytic composition, which may comprise one or more electrolytic components. Examples of solid electrolyte components include sulphurous compounds, alone or in mixture with other components such as polymers or gels. Thus, they include partially or completely crystallized, as well as amorphous sulphides. Examples of these materials may be selected from sulphides having the composition A Li₂S—B P₂S₅ (wherein 0<A<1.0<B<1 and A+B=1) and derivatives thereof (e.g. doped with Lil, LiBr, LiCl, etc.); sulphides with argyordite structures; or LGPS (Li₁₀GeP₂S₁₂) and derivatives thereof. The electrolytic materials may also comprise oxysulphides, oxides (garnet, phosphate, anti-perovskite, etc.), hydrides, polymers, or conductive ionic lithium-ion gels or liquids.

Examples of electrolytic sulphide compositions are described, inter alia, in Park, K. H., Bai, Q., Kim, D. H., Oh, D. Y., Zhu, Y., Mo, Y., & Jung, Y. S. (2018). Design Strategies, Practical Considerations, and New Solution Processes of Sulfide Solid Electrolytes for All-Solid-State Batteries. Advanced Energy Materials, 1800035.

In all-solid elements, the electrolytic compounds may be included in the electrolytic layer, but they may also be contained in part within the electrodes.

According to the invention, the protective casing may consist of one or more components. It may also comprise one or more layers, each of which consisting of one or more components.

In one embodiment, the casing consists of a first chemical protection layer and a second mechanical reinforcement layer.

In one embodiment, the casing is applied in direct contact with at least part or all of the lateral surface of the electrolytic layer.

To this end, it is desirable for at least one of the materials forming the casing to have sufficient affinity to the sulphurous electrolyte, so as to ensure direct contact between the casing and the electrolytic layer and/or the sulphurous electrolyte without degrading it.

In another embodiment, the casing is not in direct contact with the elements of the stack, in that a space is created between the casing and the elements of the stack. This space may be under vacuum or filled with a gas, in particular an inert gas.

The casing according to the invention ensures chemical protection by inhibiting contact of the elements of the element, in particular the electrolytic layer, with the atmosphere and moisture. In addition to avoiding deterioration of the sulphurous materials in the event of exposure to moisture or oxygen (and thus adversely affecting the electrochemical performance of the cell), the casing also makes it possible to limit the H₂S (harmful gas) emissions that may result from this exposure. Thus, the casing addresses a dual risk in terms of safety and performance.

Thus, according to the invention, the casing ensures chemical protection in that it reduces the generation of H₂S to less than 1 g/h/m² of the bundle surface, preferably less than 0.1 g/h/m².

‘Bundle’, as used herein, refers to the volume delimited by the plane defined by each of the electrodes, and the thickness of the bundle corresponding to the to the geometrical dimension perpendicular to the plane of the electrodes.

Thus in one embodiment, the casing comprises at least one material having a water permeability less than 0.1 g/m²/d/μm.

In one embodiment, the casing comprises at least one material having a water, nitrogen, and oxygen permeability less than 0.1 g/m²/d/μm.

Additionally, it may also ensure mechanical reinforcement, in particular by absorbing volume variations of the element over the charge-discharge cycles. This advantageously solves problems of loss of cohesion and contact that may occur following the inflation/deflation of the materials during lithium transfer (example of alloy materials and conversion with significant volume variations or lithium plating).

Thus, in one embodiment, the casing has an elongation at break greater than 150%.

In particular, the casing may have an elastic modulus between 0.001 and 50 GPa.

Typically, the casing may tolerate a bundle thickness variation of more than 10%, preferably at least 20%.

Advantageously, the casing maintains its water-permeability properties even after a volume variation of more than 10%, preferably greater than 20%.

According to the invention, the protective casing is insulating: it has an electronic conductivity typically less than 10⁻⁹ S/cm.

In one embodiment, the casing consists of an electronically non-conductive material.

In one embodiment, the casing comprises at least:
one organic material selected from thermoplastic or thermosetting polymers. They may also be copolymers or polymer mixtures. and, optionally,
one nanometer-sized inorganic material that may be in the form of particles, fibers, or tubes. Examples of possible nano-scale additives include alumina, silicates, or titanates.

Examples of materials suited to be components of the casing include: elastomers (e.g. natural or synthetic rubber, etc.), dyMAT ClrPYE MONO (marketed by COVEME), dyMAT HDPYE SPV L (marketed by COVEME), Ultra Barrier Solar Film (marketed by 3M), polyethylene terephtalate (PET), polyethylene (PE), poly(methyl methacrylate) (PMMA), polyvinylidene fluoride (PVDF), polypropylene (PP), polycarbonate (PC), poly(ethylene-co-tetrafluoroethylene) (ETFE), polyimide (PI), Polyisobutene (PIB), and derivatives and mixtures thereof.

Some of these materials have a multilayered structure:

ClrPYE Mono: Ultra protective coating/PET/primer (5 μm/175 μm/100 μm);

DyMAT HDPYE SPV L: PET/PET/Primer (50 μm/250 μm/50 μm);

Ultra Barrier Solar Film: Fluoropolymer/Black tape/Pressure sensitive adhesive/PET.

Typically, the casing has a total thickness of less than 100 μm, preferably less than 50 μm, more preferably less than 30 μm.

Generally, the circumference of the casing depends on the bundle thickness and the bundle circumference. Thus, without being bound to any theory, the circumference of the casing may advantageously be defined by the following expression:

2*k*bundle thickness+bundle circumference,

Such that k>0.1, in particular such that 0.2≤k≤0.3.

Typically, the casing has a melting point greater than or equal to 150° C.

In order to limit energy losses, the casing advantageously has a grammage of less than 5 mg/cm².

Electrochemical elements according to the invention are suited to operate over a wide range of temperatures, typically of less than 70° C. They may be stored stably at temperatures of up to −40° C.

According to another object, this invention also concerns a method for manufacturing an element according to the invention, wherein the method comprises:
manufacturing the stack and
depositing a casing as defined supra, e.g. by atomic layer deposition (ALD), molecular layer deposition (MLD), lamination, sealing, spraying, and/or physical vapor deposition.

In one embodiment, the casing is deposited by thin layer deposition in a thickness between a few atoms or molecules to several tens of nanometers.

The deposition may advantageously be carried out by ALD (atomic layer deposition), MLD (molecular layer deposition), or any other technique allowing for optimal coverage of the exposed surfaces and the interstices with the retained material.

In another embodiment, thicker protective casings (1-1000 μm) may also be deposited by techniques adapted to cell configuration (PVD, spraying, dip coating, lamination, thermoforming, etc.).

As appropriate, different materials may be used for the deposition of the protective casing for each of the electrodes and the electrolyte.

In one embodiment, the method may also comprise depositing two distinct successive layers: a first layer providing insulation and chemical stability at the nano-/micrometer scale, followed by the deposition of a second layer to maintain the mechanical cohesion of the stack.

In one embodiment, the electrochemical element according to the invention may be manufactured by a method comprising the steps of:
manufacturing an element according to the invention;
inserting the cell formed into a casing comprising at least one watertight polymer material; and
sealing the casing.

The sealing can, for example, be done by welding, fusion, or lamination.

The casing may, for example, be thermoformed prior to the insertion of the cell and the sealing.

In one embodiment, the casing comprises an adhesive material allowing for the sealing of the casing.

According to another object, the invention also concerns an electrochemical module comprising the stack of at least two elements according to the invention, wherein each element is electrically connected with one or more other elements, in particular via their current collectors.

In such an assembly, it is thus understood that all or part of the outer surface of the module is covered by the casing as defined supra.

This assembly may be made in the form of a stack. The casing is then present over at least all or part of the lateral surface of the module. Thus, the lateral outer surface of the module and/or the lower and upper outer surfaces of the electrodes may be covered by the casing.

In one embodiment, the module may also comprise the casing over its upper and lower outer surfaces, defined by the outer surface of the lower electrode and the outer surface of the upper electrode.

The module may be encapsulated within a watertight compartment, thus allowing it to be confined, e.g., in the event of overheating or leakage.

According to another object, this invention also concerns a battery comprising one or more modules according to the invention and/or one or more compartments according to the invention.

### BRIEF DESCRIPTION OF THE DRAWINGS

FIGS. 1A-1C show an element according to the invention that is not protected FIG. 1A, protected by a casing according to the invention FIGS. 1B and 1C, wherein the envelope provides a chemical protection layer FIG. 1B or a mechanical reinforcement layer FIGS. 1C.

FIG. 2 shows a module comprising an assembly of elements according to the invention.

FIG. 3 shows the inhibition of H2S production by means of the casing according to the invention.

### DETAILED DESCRIPTION

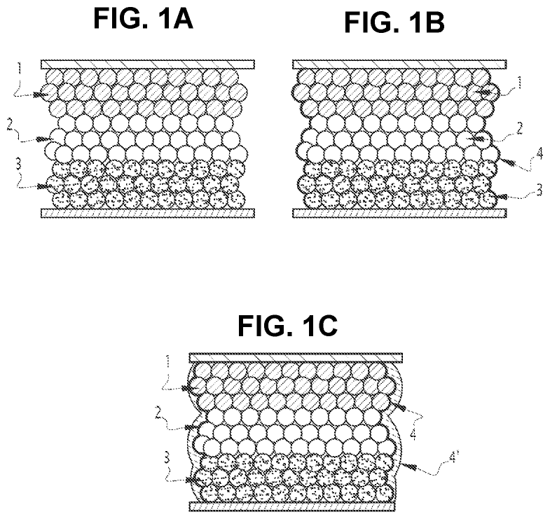

As shown in FIGS. 1A-1C, a stack suited for the invention consists of an elementary assembly of a positive electrode (1) and a negative electrode (2), separated by a catalytic layer (3). In one variant, the electrodes (1) and (2) may, of course, be reversed.

An element comprising a protective casing (4) according to the invention is shown in FIGS. 1B and 1C: In one variant, the casing (4) consists of a thin layer (4) that provides chemical production. In another variant, the casing (4) consists of a first layer (4) that provides chemical protection and a second layer (4′) that is thicker and provides mechanical reinforcement.

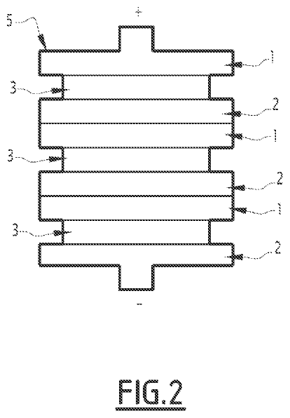

An illustrative module according to the invention is shown in FIG. 2. In this schematic representation, a module consists of three elements that are stacked. Each element consists of a positive electrode (1) and a negative electrode (2), which are separated by a catalytic layer (3). In the variant shown, the casing (4) covers the lateral surface of the module, as well as the lower and upper surfaces of the module, which are defined by the outer surfaces of the lower and rear electrode of the assembly.

The following examples are provided to illustrate the invention, without limiting its scope in any way.

### EXAMPLES

### Example 1

In order to validate the chemical protection of the casing according to the invention, an experiment was conducted with pouches of selected encapsulation materials.

An argyrodite sulphide electrolyte having the composition Li₆PS₅Cl was produced by mechanical synthesis (500 rpm, 20 h) from the precursors Li₂S, P₂S₅, and LiCl in stoichiometric proportions. The ionic conductivity of this electrolyte was measured by impedance spectroscopy on a pellet compressed at 250 MPa in a pressurized cell, and reached 1 mS/cm at room temperature (RT).

On the other hand, the sulphide electrolyte powder obtained was compressed at 250 MPa to form a pellet 400 μm in thickness and 10 mm in diameter.

A casing (example #2) was made by arranging a sheet of dyMAT ClrPYE MONO (285 μm—marketed by COVEME) and a sheet of Ultra Barrier Solar Film (203 μm—marketed by 3M™) on either side of the sulphide electrolyte pellet. The edges of the casing thus formed, which go beyond the pellet, are then heat-sealed at 150° C. so as to contain the pellet without deterioration.

In a hermetic receptacle of a known volume filled with humid ambient air, the pellet thus enclosed was inserted and the H₂S levels were measured using a specific sensor as a function of time.

Another casing (example #3) was produced according to the same procedure, but with sheets of dyMAT ClrPYE MONO (285 μm—COVEME) and dyMAT HDPYE SPV L (300 μm—COVEME) on either side of the pellet.

For comparative purposes, on the other hand, this measurement was taken using a sulphide electrolyte pellet without a casing.

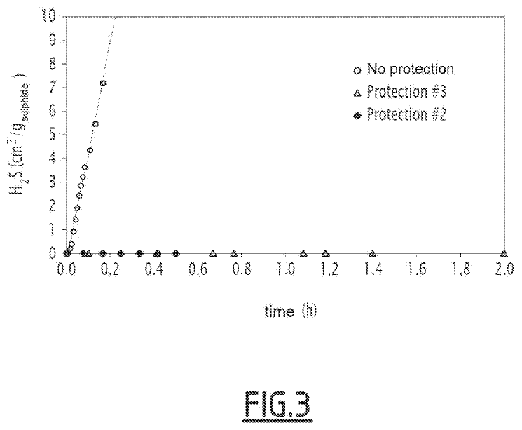

As shown in FIG. 3, the unprotected material (comparative example) rapidly emits a substantial amount of H₂S gas (10 cm³/g in less than 15 minutes), thus exceeding the limit provided by applicable regulations. With the moisture barrier protections tested, the H₂S level remains below 1 ppm (detection limit of the sensor used) for over 30 minutes (#2) to more than 2 hours (#3), and remains low after 24 h. Thus, the sulphide material may be safely handled in ambient air.

### Example 2

Given the sensitivity of the materials used to the ambient atmosphere, the following manipulations were carried out in environments having a dew point of less than −50° C., and can be carried out in an argon atmosphere.

Sulphide electrolyte powder (as produced in example 1) was cold-compressed (200 MPa) in a pellet mill to form a pellet approximately 400 μm in thickness (‘electrolytic layer’). Sulphide electrolyte powder was mixed with a mortar and pestle with powder of active positive material (NCA) in a mass ratio of NCA:SE 70:30 until a homogeneous distribution was reached. This mixture (which constitutes the positive electrode) was added to one side of the electrolytic layer in the pellet mill, and the assembly was then compressed again (200 MPa) to form a dense, solid pellet (with a thickness of the positive electrode near 100 μm). On the other side of the electrolytic layer, the negative electrode, consisting of graphite and solid electrolyte powder previously manually mixed by mortar and pestle (mass ratio electrolyte: graphite 40:60), was added. The entire stack was once again cold compressed (500 MPa) in a pellet mill an electrically insulating body so as to form the negative electrode layer with a thickness of approximately 100 μm. The masses of the positive and negative electrodes were balanced so as to give the negative electrode a slight excess capacity. The stack thus obtained was arranged between stainless steel current collectors.

The encapsulation according to the invention may be carried out on the stack thus produced. In this example, the casings described in example 1 were used for this encapsulation. The stack was introduced into one of these casings, the sides of which were then heat-sealed. Watertight current passengers (wires or clips used for the pouch cell assembly) ensure the electrical connection between the current collectors and the cycle cell without deterioration of the impermeability of the casing.

The stack thus encapsulated was then arranged in a cycle cell allowing for the application of a pressure (1-500 MPa) depending on the axis of symmetry of the pellet on both collectors without generating short circuits or deterioration of the casing.

To evaluate electrochemical performance, the cell thus assembled was then subjected to galvanostatic cycling between 2.8 and 4.1 V with a constant current such that the cell was totally charged in 20 h.

1. An electrochemical element comprising at least one sulphurous electrolytic compound, wherein the element comprises a stack of two conductive electronic current collectors, wherein the stack comprises:
a positive electrode;
a negative electrode; and
a layer comprising a solid electrolytic composition separating the positive electrode and the negative electrode;
wherein the cell is characterised in that at least the lateral surface of the stack is at least partially covered with a chemical protection and/or mechanical reinforcement casing that is electrically insulating, and that the circumference of the casing is equal to: 2*k*bundle thickness+bundle circumference,
such that
k>0.1, and
the bundle is the volume delimited by the plane defined by each of the electrodes, and the thickness of the bundle corresponding to the to the geometrical dimension perpendicular to the plane of the electrodes.

2. The element according to claim 1, such that the protective casing consists of an electronically non-conductive material.

3. The element according to claim 1, such that the casing comprises at least:
one organic material and, optionally,
one nanometre-sized inorganic material.

4. The element according to claim 1, such that the casing consists of a first chemical protection layer and a second mechanical reinforcement layer.

5. The element according to claim 1, such that the casing has a total thickness less than 100 μm and a grammage less than 5 mg/cm².

6. The element according to claim 1, such that the casing comprises at least one material having a water permeability less than 0.1 g/m²/d/μm.

7. The element according to claim 1, such that the casing has an elongation at break greater than 150%.

8. The element according to claim 1, such that the casing contains one or more components selected from elastomers (e.g. natural or synthetic rubbers, etc.), dyMAT ClrPYE MONO (multilayered structure of Ultra protective coating/PET/primer (5 μm/175 μm/100 μm) marketed by COVEME), dyMAT HDPYE SPV L (PET/PET/Primer (50 μm/250 μm/50 μm) marketed by COVEME), Ultra Barrier Solar Film (Fluoropolymer/Black tape/Pressure sensitive adhesive/PET marketed by 3M), polyethylene terephtalate (PET), polyethylene (PE); poly(methyl methacrylate) (PMMA); polyvinylidene fluoride (PVDF); polypropylene (PP); polycarbonate (PC); poly(ethylene-co-tetrafluoroethylene) (ETFE); polyimide (PI); Polyisobutene (PIB), and derivatives and mixtures thereof.

9. A method for manufacturing an element according to claim 1, comprising:
manufacturing the stack and
depositing a casing as defined according to claim 1, in particular by atomic layer deposition (ALD), molecular layer deposition (MLD), spraying, and/or physical vapour deposition.

10. A electrochemical module comprising the stack of at least two elements according to claim 1, wherein each element is electrically connected to one or more other elements, and such that all or part of the module covered with a casing as defined according to claim 1.

11. A watertight module comprising a module according to claim 10 inside a watertight compartment.

12. A battery comprising one or more modules according to claim 10.

13. The battery comprising one or more watertight modules according to claim 11.
